(19) United States
(12) Patent Application Publication
(10) Pub. No.: US 2007/0078212 A1
(43) Pub. Date: Apr. 5, 2007

(54) NANOCOMPOSITE COMPOSITION HAVING BARRIER PROPERTY AND PRODUCT USING THE SAME

(75) Inventors: Myung-Ho KIM, Daejon (KR); YoungTock OH, Daejeon (KR); Chongkoo KUM, Daejeon (KR); YoungChul YANG, Daejeon (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/534,068

(22) Filed: Sep. 21, 2006

(30) Foreign Application Priority Data
Sep. 22, 2005 (KR) 10-2005-0088318

(51) Int. Cl. C08K 9/04

(52) U.S. Cl. 524/445; 524/606

(57) ABSTRACT

Disclosed herein is a nanocomposite composition having barrier properties. The nanocomposite composition is prepared by dry-blending a polyamide resin and a nanocomposite having barrier properties composed of polyamide and a layered clay. Since the nanocomposite composition has superior barrier properties and good moldability, it is suitable for use in the manufacture of closed containers, sheets having barrier properties, and films having barrier properties. Further disclosed is an article manufactured from the nanocomposite composition.

### FIELD OF THE INVENTION

The present invention relates to a nanocomposite composition having barrier properties and an article manufactured from the nanocomposite composition. More particularly, the present invention relates to a nanocomposite composition with superior barrier properties and good moldability, which is prepared by dry-blending a polyamide resin and a polyamide/layered clay nanocomposite, and an article manufactured from the nanocomposite composition.

### BACKGROUND OF THE INVENTION

General-purpose resins, such as polyethylene and polypropylene, are currently used in various applications for their good moldability, excellent mechanical properties and superior moisture-barrier properties. Although these resins have superior barrier performance against gases, they suffer from limitations in applications thereof for food packaging that requires oxygen-barrier properties and agrochemical containers that require chemical-barrier properties.

On the other hand, ethylene-vinyl alcohol copolymers and polyamide resins advantageously offer superior gas-barrier properties and high transparency. Despite these advantages, however, since ethylene-vinyl alcohol copolymers and polyamide resins are more expensive than general-purpose resins, they are used in limited amounts in finished products.

A number of techniques have been proposed in terms of cost effectiveness, for example, a resin composition prepared by mixing and blending a resin having barrier properties, such as an ethylene-vinyl alcohol copolymer or a polyamide resin, with low-priced polyolefin. However, satisfactory barrier properties could not still be achieved.

Currently used nanocomposites having improved barrier properties are prepared by dispersing a nano-sized, layered clay in a polymer matrix. These nanocomposites have a structure in which the layered clay is dispersed in a fully exfoliated, partially exfoliated, intercalated or partially intercalated form.

U.S. Pat. No. 5,385,776 discloses a nanocomposite prepared by melt-compounding polyamide in a molten state with a layered clay to intercalate the polyamide between layers of the layered clay, followed by mechanical mixing to exfoliate the layered clay. However, the barrier properties of molded articles manufactured from the nanocomposite are not improved satisfactorily.

Thus, there is a need for a resin composition that maintains a morphology advantageous for barrier properties even after molding and has good processability, thereby facilitating the manufacture of containers, sheets and films.

### SUMMARY OF THE INVENTION

Therefore, it is one object of the present invention to provide a nanocomposite composition that has high mechanical strength, superior chemical-barrier properties, such as oxygen-, organic solvent- and moisture-barrier properties, and good moldability.

It is another object of the present invention to provide an article manufactured from the nanocomposite composition having barrier properties.

In accordance with one aspect of the present invention for achieving the above objects, there is provided a composition prepared by dry-blending (a) 40 to 97 parts by weight of a polyamide resin and (b) 3 to 60 parts by weight of a nanocomposite having barrier properties composed of polyamide and a layered clay.

In one embodiment of the composition according to the present invention, the weight ratio of the polyamide to the layered clay in the nanocomposite having barrier properties may be in the range of 58.0:42.0 to 99.9:0.1.

In a further embodiment of the composition according to the present invention, the viscosity ratio of the polyamide (a) to the polyamide/layered clay nanocomposite having barrier properties (b) may be in the range of 1.0:3.0 to 3.0:1.0, as measured relative to the viscosity of sulfuric acid.

In another embodiment of the composition according to the present invention, the polyamide may be selected from 1) nylon 46, 2) nylon 6, 3) nylon 66, 4) nylon 610, 5) nylon 7, 6) nylon 8, 7) nylon 9, 8) nylon 11, 9) nylon 12, 10) nylon 46, 11) MXD6, 12) amorphous polyamide, 13) a polyamide copolymer containing two or more polyamides of the polyamides 1) to 12), and 14) mixtures of two or more polyamides of the polyamides 1) to 12).

In accordance with another aspect of the present invention, there is provided an article manufactured from the nanocomposite composition having barrier properties.

In one embodiment of the article according to the present invention, the article may be manufactured by blow molding, extrusion molding, pressure molding, or injection molding.

In a further embodiment of the article according to the present invention, the article may have a monolayer or multilayer structure.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are cross-sectional views schematically showing the shapes of an article in machine and transverse directions, respectively, which is manufactured from a nanocomposite composition having barrier properties according to one embodiment of the present invention.

### DETAILED DESCRIPTION OF PREFERRED EMBODIMENTS

The present invention will now be described in more detail.

The present invention provides a nanocomposite composition having barrier properties prepared by dry-blending a polyamide resin and a nanocomposite having barrier properties composed of polyamide and a layered clay.

Specifically, the nanocomposite composition of the present invention is prepared by dry-blending (a) 40 to 97 parts by weight of a polyamide resin and (b) 3 to 60 parts by weight of a nanocomposite having barrier properties composed of polyamide and a layered clay.

The polyamide resin used in the present invention may be selected from 1) nylon 46, 2) nylon 6, 3) nylon 66, 4) nylon 610, 5) nylon 7, 6) nylon 8, 7) nylon 9, 8) nylon 11, 9) nylon 12, 10) nylon 46, 11) MXD6, 12) amorphous polyamide, 13) a polyamide copolymer containing two or more polyamides of the polyamides 1) to 12), and 14) mixtures of two or more polyamides of the polyamides 1) to 12).

The term “amorphous polyamide” as herein used refers to a polyamide that lacks in crystallinity, which has no endothermic crystalline melting peak when measured using a differential scanning calorimeter (DSC) (ASTM D-3417, 10° C./min.).

In general, the polyamide can be prepared from a diamine and a dicarboxylic acid. Examples of suitable diamines include hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidene, 1,4-diaminocyclohexane, 1,3-diaminocyclohexane, meta-xylylenediamine, 1,5-diaminopentane, 1,4-diaminobutane, 1,3-diaminopropane, 2-ethyldiaminobutane, 1,4-diaminomethylcyclohexane, meta-xylylenediamine, alkyl-substituted or unsubstituted m-phenylenediamine, and p-phenylenediamine. Examples of suitable dicarboxylic acids include alkyl-substituted or unsubstituted isophthalic acid, terephthalic acid, adipic acid, sebacic acid, and butanedicarboxylic acid.

Polyamide prepared from an aliphatic diamine and an aliphatic dicarboxylic acid is general semi-crystalline polyamide (also referred to as ‘crystalline nylon’) and is not amorphous polyamide. Polyamide prepared from an aromatic diamine and an aromatic dicarboxylic acid is difficult to treat under common conditions for melting processes.

Accordingly, amorphous polyamide can be prepared from either an aromatic diamine and an aliphatic dicarboxylic acid or an aromatic dicarboxylic acid and an aliphatic diamine. Aliphatic groups of the amorphous polyamide are preferably C₁-C₁₅ aliphatic groups or C₄-C₈ alicyclic alkyl groups. Aromatic groups of the amorphous polyamide are preferably substituted C₁-C₆ mono- or bicyclic aromatic groups. However, all types of the amorphous polyamide are not necessarily suitable for use in the present invention. For example, meta-xylylenediamine adipamide is readily crystallized under typical heating conditions for a thermal molding process or when being oriented, which is unfavorable.

Specific examples of amorphous polyamides suitable for use in the present invention include hexamethylenediamine isophthalamide, a hexamethylenediamine isophthalamide/terephthalamide terpolymer having an isophthalic acid/terephthalic acid ratio of 99/1 to 60/40, a mixture of 2,2,4- and 2,4,4-trimethylhexamethylenediamine terephthalamide, and a copolymer of isophthalic acid, terephthalic acid or a mixture thereof with hexamethylenediamine or 2-methylpentamethylenediamine. Polyamide based onhexamethylenediamine isophthalamide/terephthalamide, which has a high terephthalic acid content, is also useful, but it must be mixed with another diamine, such as 2-methyldiaminopentane, in order to produce a processible amorphous polyamide.

The amorphous polyamide based on the above monomers only may contain a small amount of a lactam, such as caprolactam or lauryl lactam, as a co-monomer. Importantly, the polyamide must be amorphous in its entirety. Therefore, any co-monomer can be used in the present invention so long as it does not male the polyamide crystalline. The amorphous polyamide may include about 10% by weight or less of a liquid or solid plasticizer, such as glycerol, sorbitol or toluenesulfonamide (Santicizer 8, Monsanto). In most applications, the T_{g} of the amorphous polyamide (as measured in a dry state, i.e. a state in which about 0.12% by weight or less of moisture is contained) must be within the range of about 70° C. to about 170° C. and preferably about 80° C. to about 160° C. The amorphous polyamide, which is not specially blended, has a T_{g} of about 125° C. in a dry state. The lower limit of the T_{g} of the amorphous polyamide is approximately 70° C., although it is not clearly defined. The upper limit of the T_{g} of the amorphous polyamide is not clearly defined, either. However, the use of the polyamide having a T_{g} higher than about 170° C. makes thermal molding of the final composition difficult. Therefore, polyamide having aromatic groups at both acid and amine moieties cannot be thermally molded because it has too high a T_{g}, which is not generally suitable for the objects of the present invention. The polyamide may also be semi-crystalline.

The semi-crystalline polyamide is generally prepared using a lactam, such as nylon 6 or nylon 11, or an amino acid, or is prepared by condensing a diamine, such as hexamethylenediamine, with a dibasic acid, such as succinic acid, adipic acid or sebacic acid. The polyamide may be a copolymer or a terpolymer, for example, a copolymer (e.g., nylon 6, nylon 66) of hexamethylenediamine/adipic acid and caprolactam. A mixture of two or more crystalline polyamides may also be used. The semi-crystalline and amorphous polyamides are prepared by polycondensation processes well known in the art.

The polyamide resin (a) is preferably used in an amount of 40 to 97 parts by weight. When the polyamide resin is used in an amount smaller than 40 parts by weight, it is difficult to maintain the morphology in a continuous phase and the elongation of a final molded article is lowered. When the polyamide resin is used in an amount greater than 97 parts by weight, sufficient improvement of barrier properties is not expected.

The polyamide/layered clay nanocomposite having barrier properties is prepared by adding polyamide to a layered clay, and fully or partially exfoliating the layered clay on a nanometer scale. The nanocomposite having barrier properties lengthens permeation pathways of gases and liquids formed within the polyamide resin, so that the moisture-barrier properties and liquid-barrier properties of the polyamide resin itself can be improved. In addition, the use of the polyamide identical to the polyamide resin in a continuous phase avoids the need to use a compatibilizer.

The combination of the polyamide resin and the polyamide/layered clay nanocomposite having barrier properties overcomes the disadvantages, such as poor moisture- and alcohol-barrier properties, encountered in the use of the polyamide resin alone, and further results in an increase in oxygen-barrier properties.

The weight ratio of the polyamide resin to the layered clay in the nanocomposite having barrier properties is in the range of 58.0:42.0 to 99.9:0.1 and preferably 85.0:15.0 to 99.0:1.0. When the polyamide resin is present in an amount of less than 58.0% by weight, the layered clay aggregates and is thus not suitably dispersed in the nanocomposite. Meanwhile, when the resin having barrier properties is present in an amount exceeding 99.9% by weight, an improvement in barrier properties is undesirably negligible.

It is preferred that the layered clay be organically modified by intercalating an organic modifier between layers of the layered clay. The organic modifier may be an organic material having a functional group selected from the group consisting of primary ammonium, secondary ammonium, tertiary ammonium, quaternary ammonium, phosphonium, maleate, succinate, acrylate, benzylic hydrogen, oxazoline, and distearyldimethylammonium groups. The content of the organic modifier in the layered clay is preferably in the range of 1 to 45% by weight. The use of the organic modifier in an amount of less than 1% by weight causes poor compatibility between the layered clay and the polymer. Meanwhile, the use of the organic modifier in an amount exceeding 45% by weight makes it difficult to intercalate chains of the polymer between layers of the layered clay.

The layered clay is preferably one or more selected from the group consisting of montmorillonite, bentonite, kaolinite, mica, hectorite, fluorohectorite, saponite, beidellite, nontronite, stevensite, vermiculite, hallosite, volkonskoite, suconite, magadite, kenyalite, and the like. The organic modifier is preferably an organic material having a functional group selected from the group consisting of primary ammonium, secondary ammonium, tertiary ammonium, quaternary ammonium, phosphonium, maleate, succinate, acrylate, benzylic hydrogen, oxazoline, and distearyldimethylammonium groups.

The polyamide/layered clay nanocomposite having barrier properties is preferably used in an amount of 3 to 60 parts by weight. When the nanocomposite having barrier properties is used in an amount of less than 3 parts by weight, an improvement in barrier properties is insignificant. Meanwhile, when the nanocomposite having barrier properties is used in an amount exceeding 60 parts by weight, the processability of the nanocomposite composition is undesirably deteriorated.

The viscosity ratio of the polyamide (a) to the polyamide/layered clay nanocomposite having barrier properties (b) may be in the range of 1.0:3.0 to 3.0:1.0, as measured relative to the viscosity of sulfuric acid. The relative viscosity can be measured by a sulfuric acid (96%) process.

When the viscosity ratio falls outside the range, a multiple lamellar morphology of the nanocomposite is not easily formed.

The present invention also provides an article having barrier properties manufactured from the nanocomposite composition having barrier properties. The nanocomposite composition having barrier properties is molded while the morphology of the nanocomposite having barrier properties is maintained to manufacture a molded article. Since the molded article thus manufactured also has a structure in which the exfoliated nanocomposite is dispersed in a polyamide matrix, it has superior barrier properties.

The molding may be carried out by common molding processes, such as blow molding, extrusion molding, pressure molding and injection molding.

Examples of such molded articles having barrier properties include containers, sheets having barrier properties, and films having barrier properties.

The article having barrier properties may have a monolayer and multilayer structure. The multilayer structure of the article may further include an adhesive layer and a polyolefin layer.

Hereinafter, the present invention will be explained in more detail with reference to the following examples. However, these examples are given for the purpose of illustration and are not intended to limit the present invention.

### EXAMPLES

Materials used in the following examples are as follows:

Amorphous nylon: SELAR 2072, DuPont, USA

Nylon 612: Zytel 158L, DuPont, USA

Nylon 6: EN 500, KP Chemicals, Korea

Clay: Cloisite 20A, SCP

Heat stabilizer: IR 1098, Songwon Industrial Co., Ltd., Korea

### Preparative Example 1

### Preparation of Nylon 6-Layered Clay Nanocomposite

97 wt % of polyamide (nylon 6) was introduced into a main hopper of a co-rotating twin screw extruder (Φ40) (SM Platek Co., Ltd., Korea). Then, 3.0 wt % of organically modified montmorillonite as a layered clay, and 0.1 parts by weight of a heat stabilizer (IR 1098) based on a total of 100 parts by weight of the polyamide and the layered clay were separately introduced into a side feeder to prepare a nylon 6/layered clay nanocomposite in a pellet form. Extrusion was carried out under the following conditions: extrusion temperature of 220-225-245-245-245-245-245° C., screw rotation speed of 300 rpm, and discharge rate of 40 kg/hr.

### Preparative Example 2

### Preparation of Amorphous Nylon-Layered Clay Nanocomposite

97 wt % of amorphous nylon was introduced into a main hopper of a co-rotating twin screw extruder (Φ40) (SM Platek Co., Ltd., Korea). Then, 3.0 wt % of organically modified montmorillonite as a layered clay, and 0.1 parts by weight of a heat stabilizer (IR 1098) based on a total of 100 parts by weight of the amorphous nylon and the layered clay were separately introduced into a side feeder to prepare a amorphous nylon/layered clay nanocomposite in a pellet form. Extrusion was carried out under the following conditions: extrusion temperature of 215-225-235-235-235-235-240° C., screw rotation speed of 300 rpm, and discharge rate of 40 kg/hr.

### Preparative Example 3

### Preparation of Nylon 612-Layered Clay Nanocomposite

97 wt % of nylon 612 was introduced into a main hopper of a co-rotating twin screw extruder (Φ40) (SM Platek Co., Ltd., Korea). Then, 3.0 wt % of organically modified montmorillonite as a layered clay, and 0.1 parts by weight of a heat stabilizer (IR 1098) based on a total of 100 parts by weight of the polyamide and the layered clay were separately introduced into a side feeder to prepare a nylon 612/layered clay nanocomposite in a pellet form. Extrusion was carried out under the following conditions: extrusion temperature of 225-245-245-245-245-245-240° C., screw rotation speed of 300 rpm, and discharge rate of 40 kg/hr.

### Example 1

15 parts by weight of the nylon 6/layered clay nanocomposite prepared in Preparative Example 1 and 85 parts by weight of nylon 6 were dry-blended, followed by blow molding to manufacture a pipe (wall thickness: 5 mm, outer diameter: 30 mm). The molding was carried out at processing temperatures of 185-195-195-195-195-190° C. and a screw rotation speed of 16 rpm.

### Example 2

A pipe was manufactured in the same manner as in Example 1, except that 15 parts by weight of the nylon 612/layered clay nanocomposite prepared in Preparative Example 2 was used.

### Example 3

A pipe was manufactured in the same manner as in Example 1, except that 15 parts by weight of the amorphous nylon/layered clay nanocomposite prepared in Preparative Example 3 was used.

### Example 4

15 parts by weight of the nylon 6/layered clay nanocomposite prepared in Preparative Example 1 and 85 parts by weight of nylon 612 were dry-blended, followed by blow molding to manufacture a pipe (wall thiclness: 5 mm, outer diameter: 30 mm). The molding was carried out at processing temperatures of 185-195-195-195-195-190° C. and a screw rotation speed of 16 rpm.

### Example 5

A pipe was manufactured in the same manner as in Example 4, except that 15 parts by weight of the nylon 612/layered clay nanocomposite prepared in Preparative Example 2 was used.

### Example 6

A pipe was manufactured in the same manner as in Example 4, except that 15 parts by weight of the amorphous nylon/layered clay nanocomposite prepared in Preparative Example 3 was used.

### Example 7

15 parts by weight of the nylon 6/layered clay nanocomposite prepared in Preparative Example 1 and 85 parts by weight of amorphous nylon were dry-blended, followed by blow molding to manufacture a pipe (wall thickness: 5 mm, outer diameter: 30 mm). The molding was carried out at processing temperatures of 185-195-195-195-195-190° C. and a screw rotation speed of 16 rpm.

### Example 8

A pipe was manufactured in the same manner as in Example 7, except that 15 parts by weight of the nylon 612/layered clay nanocomposite prepared in Preparative Example 2 was used.

### Example 9

A pipe was manufactured in the same manner as in Example 7, except that 15 parts by weight of the amorphous nylon/layered clay nanocomposite prepared in Preparative Example 3 was used.

### Example 10

5 parts by weight of the amorphous nylon/layered clay nanocomposite prepared in Preparative Example 3 and 95 parts by weight of nylon 6 were dry-blended, followed by blow molding to manufacture a pipe (wall thiclness: 5 mm, outer diameter: 30 mm). The molding was carried out at processing temperatures of 185-195-195-195-195-190° C. and a screw rotation speed of 16 rpm.

### Example 11

45 parts by weight of the amorphous nylon/layered clay nanocomposite prepared in Preparative Example 3 and 55 parts by weight of nylon 6 were dry-blended, followed by blow molding to manufacture a pipe (wall thiclness: 5 mm, outer diameter: 30 mm). The molding was carried out at processing temperatures of 220-235-235-235-235-240° C. and a screw rotation speed of 13 rpm.

### Example 12

45 parts by weight of the amorphous nylon/layered clay nanocomposite prepared in Preparative Example 3 and 55 parts by weight of nylon 6 were dry-blended, followed by blow molding to manufacture a pipe (wall thickness: 5 mm, outer diameter: 30 mm) having a five-layer structure of HDPE/adhesive/nanocomposite composition/adhesive/HDPE. The molding was carried out at processing temperatures of 220-235-235-235-235-240° C. and a screw rotation speed of 12 rpm.

### Comparative Example 1

100 parts by weight of nylon 6 was blow-molded to manufacture a pipe (wall thickness: 5 mm, outer diameter: 30 mm). The molding was carried out at processing temperatures of 220-235-235-235-235-240° C. and a screw rotation speed of 14 rpm.

### Comparative Example 2

85 parts by weight of nylon 6 and 15 parts by weight of nylon 612 were dry-blended, followed by blow molding to manufacture a pipe (wall thickness: 5 mm, outer diameter: 30 mm). The molding was carried out at processing temperatures of 220-235-235-235-235-240° C. and a screw rotation speed of 13 rpm.

### Comparative Example 3

85 parts by weight of nylon 6 and 15 parts by weight of amorphous nylon were dry-blended, followed by blow molding to manufacture a pipe (wall thiclness: 5 mm, outer diameter: 30 mm). The molding was carried out at processing temperatures of 220-235-235-235-235-240° C. and a screw rotation speed of 13 rpm.

### Comparative Example 4

100 parts by weight of nylon 612 was blow-molded to manufacture a pipe (wall thickness: 5 mm, outer diameter: 30 mm). The molding was carried out at processing temperatures of 220-235-235-235-235-240° C. and a screw rotation speed of 14 rpm.

### Comparative Example 5

85 parts by weight of nylon 612 and 15 parts by weight of nylon 6 were dry-blended, followed by blow molding to manufacture a pipe (wall thickness: 5 mm, outer diameter: 30 mm). The molding was carried out at processing temperatures of 220-235-235-235-235-240° C. and a screw rotation speed of 13 rpm.

### Comparative Example 6

85 parts by weight of nylon 612 and 15 parts by weight of amorphous nylon were dry-blended, followed by blow molding to manufacture a pipe (wall thickness: 5 mm, outer diameter: 30 mm). The molding was carried out at processing temperatures of 220-235-235-235-235-240° C. and a screw rotation speed of 13 rpm.

### Comparative Example 7

100 parts by weight of amorphous nylon was blow-molded to manufacture a pipe (wall thiclness: 5 mm, outer diameter: 30 mm). The molding was carried out at processing temperatures of 220-235-235-235-235-240° C. and a screw rotation speed of 14 rpm.

### Comparative Example 8

85 parts by weight of amorphous nylon and 15 parts by weight of nylon 6 were dry-blended, followed by blow molding to manufacture a pipe (wall thickness: 5 mm, outer diameter: 30 mm). The molding was carried out at processing temperatures of 220-235-235-235-235-240° C. and a screw rotation speed of 13 rpm.

### Comparative Example 9

85 parts by weight of amorphous nylon and 15 parts by weight of nylon 612 were dry-blended, followed by blow molding to manufacture a pipe (wall thiclness: 5 mm, outer diameter: 30 mm). The molding was carried out at processing temperatures of 220-235-235-235-235-240° C. and a screw rotation speed of 13 rpm.

### Comparative Example 10

95 parts by weight of nylon 6 and 5 parts by weight of amorphous nylon were dry-blended, followed by blow molding to manufacture a pipe (wall thiclness: 5 mm, outer diameter: 30 mm). The molding was carried out at processing temperatures of 220-235-235-235-235-240° C. and a screw rotation speed of 13 rpm.

### Comparative Example 11

55 parts by weight of nylon 6 and 45 parts by weight of amorphous nylon were dry-blended, followed by blow molding to manufacture a pipe (wall thickness: 5 mm, outer diameter: 30 mm). The molding was carried out at processing temperatures of 220-235-235-235-235-240° C. and a screw rotation speed of 13 rpm.

### Comparative Example 12

55 parts by weight of nylon 6 and 45 parts by weight of amorphous nylon were dry-blended, followed by blow molding to manufacture a pipe (wall thickness: 5 mm, outer diameter: 30 mm) having a five-layer structure of HDPE/adhesive/nanocomposite composition/adhesive/HDPE. The molding was carried out at processing temperatures of 220-235-235-235-235-240° C. and a screw rotation speed of 12 rpm.

The pipes manufactured in Examples 1 to 12 and Comparative Examples 1 to 12 were tested for oxygen-barrier properties. The results are shown in Table 1.

[Test for Oxygen-Barrier Properties]

First, each of the pipes manufactured in Examples 1 to 12 and Comparative Examples 1 to 12 was filled with tin to produce a packed column. While water, from which dissolved oxygen was previously removed, was circulated in the packed column, an increase in the level of dissolved oxygen in the water was measured at 20° C. and RH 65%. This increase is expressed in μg/hr, indicating an increased level (μg) of dissolved oxygen per liter of water and hour. The increase (A μg/hr) in the level of dissolved oxygen in the water was calculated by the following equation:
A=B (V1V2)

where V1 (cc) represents the volume of the water in the entire system, including the pipe, V2 (cc) represents the volume of water in the pipe, and B (μg/hr) represents the increase in the level of oxygen in the water circulating through the system per unit time.

A small increase in the level of dissolved oxygen indicates superior oxygen-barrier properties.

TABLE 1

| Example No. | μg/hr |
|---|---|
| Example 1 | 33 |
| Example 2 | 31 |
| Example 3 | 34 |
| Example 4 | 28 |
| Example 5 | 18 |
| Example 6 | 31 |
| Example 7 | 38 |
| Example 8 | 35 |
| Example 9 | 41 |
| Example 10 | 47 |
| Example 11 | 30 |
| Example 12 | 44 |
| Comparative Example 1 | 67 |
| Comparative Example 2 | 64 |
| Comparative Example 3 | 69 |
| Comparative Example 4 | 52 |
| Comparative Example 5 | 50 |
| Comparative Example 6 | 57 |
| Comparative Example 7 | 69 |
| Comparative Example 8 | 63 |
| Comparative Example 9 | 70 |
| Comparative Example 10 | 75 |
| Comparative Example 11 | 63 |
| Comparative Example 12 | 72 |

As can be seen from the data shown in Table. 1, the pipes of Examples 1 to 12, which were manufactured by dry-blending a polyamide resin and a polyamide/layered clay nanocomposite having barrier properties to prepare a nanocomposite composition and molding the nanocomposite composition, showed superior oxygen-barrier properties, as compared to the pipes of Comparative Examples 1 to 12, which were manufactured using one or two polyamides.

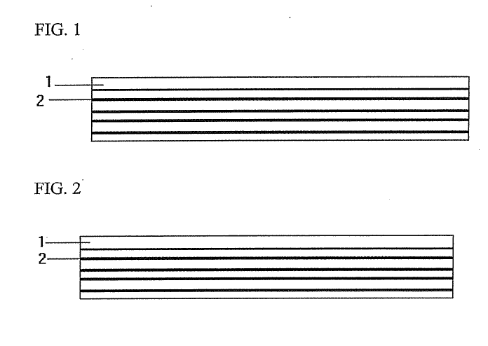

FIGS. 1 and 2 show a container manufactured from the nanocomposite composition having barrier properties according to the present invention. As shown in FIGS. 1 and 2, the nanocomposite having barrier properties is dispersed in a polyamide continuous phase, demonstrating that the container has superior barrier properties.

### INDUSTRIAL APPLICABILITY

As apparent from the foregoing, the nanocomposite composition of the present invention has superior barrier properties and good moldability. Therefore, articles, such as containers having barrier properties, sheets having barrier properties and films having barrier properties, manufactured from the nanocomposite composition show excellent performance.

In light of the above teachings, various practices and modifications of the present invention can be readily made without departing from the scope and spirit of the invention by those skilled in the art.

1. A composition prepared by dry-blending (a) 40 to 97 parts by weight of a polyamide resin and (b) 3 to 60 parts by weight of a nanocomposite having barrier properties composed of polyamide and a layered clay.

2. The composition according to claim 1, wherein the layered clay is one or more selected from the group consisting of montmorillonite, bentonite, kaolinite, mica, hectorite, fluorohectorite, saponite, beidellite, nontronite, stevensite, vermiculite, hallosite, volkonskoite, suconite, magadite, and kenyalite.

3. The composition according to claim 1, wherein the polyamide and the layered clay are present in a weight ratio of ranging from 58.0: 42.0 to 99.9: 0.1 in the nanocomposite having barrier properties.

4. The composition according to claim 1, wherein the layered clay contains 1 to 45% by weight of an organic modifier.

5. The composition according to claim 4, wherein the organic modifier is an organic material having a functional group selected from the group consisting of primary ammonium, secondary ammonium, tertiary ammonium, quaternary ammonium, phosphonium, maleate, succinate, acrylate, benzylic hydrogen, oxazoline, and distearyldimethylammonium groups.

6. The composition according to claim 1, wherein the polyamide is 1) nylon 46, 2) nylon 6, 3) nylon 66, 4) nylon 610, 5) nylon 7, 6) nylon 8, 7) nylon 9, 8) nylon 11, 9) nylon 12, 10) nylon 46, 11) MXD6, 12) amorphous polyamide, 13) a polyamide copolymer containing two or more polyamides of the polyamides 1) to 12), or 14) a mixture of two or more polyamides of the polyamides 1) to 12).

7. The composition according to claim 1, wherein the viscosity ratio of the polyamide to the polyamide/layered clay nanocomposite is in the range of 1.0:3.0 to 3.0:1.0, as measured relative to the viscosity of sulfuric acid.

8. A molded article having barrier properties manufactured from the composition according to claim 1.

9. The molded article according to claim 8, wherein the article is manufactured by blow molding, extrusion molding, pressure molding, or injection molding.

10. The article according to claim 8, wherein the article has a monolayer or multilayer structure.

11. A molded article having barrier properties manufactured from the composition according to claim 2.

12. A molded article having barrier properties manufactured from the composition according to claim 3.

13. A molded article having barrier properties manufactured from the composition according to claim 4.

14. A molded article having barrier properties manufactured from the composition according to claim 5.

15. A molded article having barrier properties manufactured from the composition according to claim 6.

16. A molded article having barrier properties manufactured from the composition according to claim 7.
